(19) United States
(12) Patent Application Publication
(10) Pub. No.: US 2004/0024507 A1
(43) Pub. Date: Feb. 5, 2004

(54) Vehicle restraint system for dynamically classifying an occupant and method of using same

(76) Inventors: David A. Hein, Sterling Heights, MI (US); John F. Nathan, White Lake Township, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(21) Appl. No.: 10/209,099

(22) Filed: Jul. 31, 2002

(51) Int. Cl. B60R 21/32

(52) U.S. Cl. 701/45; 180/273; 280/735

(57) ABSTRACT

A method for determining the rate of deployment for an air bag in a vehicle. The method includes the steps of providing at least one mass sensor' providing at least one tracking sensor; determining the mass, position, and physical characteristics of the occupant's classifying the occupant; and deploying the air bag at a predetermined rate. A system employing this method is also provided.

### BACKGROUND OF THE INVENTION

1. Field of the Invention

The present invention relates to an vehicle restraint system for dynamically classifying a vehicle occupant and a method of using the same.

2. Background Art

It is well known to use air bags in vehicle occupant restraint systems to protect the occupants in case of an impact. When an impact occurs, a crash sensor sends a signal to a controller. If the impact is severe enough, the controller sends a signal to an air bag module signaling the air bag to deploy. Numerous complaints have been filed with the National Transportation Board alleging that in some circumstances the air bags deploy with excessive force and cause more injury than would have occurred had the air bag not deployed.

Accordingly, restraint systems to prevent deployment of air bags under certain circumstances have been developed. These systems have sensors that determine the mass of the occupant. In addition, some systems may contain an independent system that detects the position of the occupant. If the restraint system detects that the occupant is out of position or that the occupant is too light, then the air bag is either deployed at a reduced rate or not deployed at all.

However, the prior art systems have difficulty determining the proper rate of deployment for the air bag because they cannot accurately classify the type of occupant based on the information the systems gather. Accordingly, there is a need for a vehicle occupant restraint system that can properly classify the vehicle occupant based on information gathered by the sensors and deploy the air bag at the proper rate.

### SUMMARY OF THE INVENTION

The present invention solves the problem of problem of classifying occupants by measuring key physical characteristics such as a distance between the occupant and a dash board, the distance between the occupant's head and a seat bottom, and the distance between the occupant's shoulders and the occupant's head.

### BRIEF DESCRIPTION OF THE DRAWINGS

FIG. 1 is a side view of a vehicle having the vehicle restraint system of the present invention and an occupant sitting in the proper position; and

FIG. 2 is a side view of a vehicle having the vehicle restraint system of the present invention and an occupant sitting out of position; and

FIG. 3 is a side view of a vehicle having the vehicle restraint system of the present invention and a rearward facing baby seat; and

FIG. 4 is a side view of a vehicle having the vehicle restraint system of the present invention and a forward facing baby seat; and

FIG. 5 is a flow chart depicting an exemplary method of classifying an occupant based on the vehicle restraint system of the present invention.

### DETAILED DESCRIPTION OF THE PREFERRED EMBODIMENT(S)

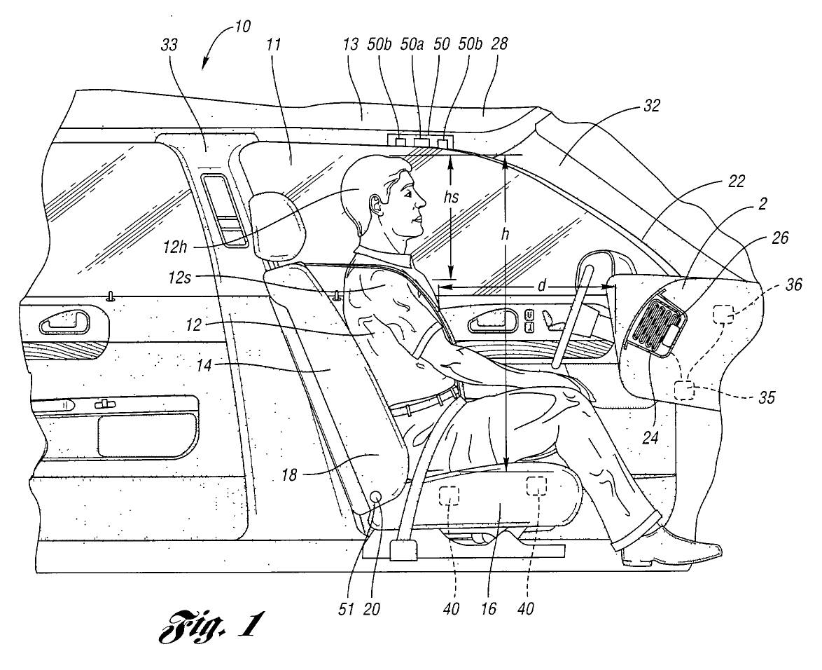

Referring now to FIG. 1, a vehicle 10 having a roof 13, an interior 11, an occupant 12, and a vehicle restraint system 2 is shown in cross section. As discussed below, the system 2 includes at least a mass sensor 40, a tracking sensor 50, and a controller 25. The vehicle 10 may be a car, truck, bus, van, or other vehicle that uses air bags for protecting its occupants. The occupant 12 is shown sitting on a seat 14 attached to the vehicle. The seat 14 has a seat bottom 16 and a seat back 18 pivotable relative to the seat bottom at pivot 20. The seat 14 is typical of most seats in vehicles and may be capable of forward, rearward, upward, downward, and pivotal movement relative to the vehicle. The seat 14 may be a driver's seat, a front passenger's seat, a rear passenger seat, or any other seat in a vehicle.

The interior of the vehicle is shown having a dash board 22 which includes an air bag module 24 having an air bag 26. An inert gas source (not shown) fills the air bag 26 upon deployment to a filled or inflated position. The inflation of the air bag 26 generally takes about 60 milliseconds and generates a considerable amount of force on the occupant. Numerous injuries have been reported to the National Transportation Board allegedly caused from air bags deploying with too much force for a particular circumstance.

The present invention works equally well for the driver of the vehicle or occupants in other seats. In such cases, the air bag module 24 would be located in another location, such as the steering wheel column (not shown) for the driver of the vehicle. Further, the invention anticipates additional air bag modules 24 or air bag modules placed in different locations such as in the doors, seats, or headliners.

The interior of the vehicle 10 may also include a headliner 28, A pillars 32, and B pillars 33 as is well known in the art. A crash sensor 36 is also provided to determine the magnitude of a crash. The crash sensor sends a signal to the controller 35 indicating that a crash has occurred. If the crash is severe enough, the controller 35 signals the air bag module 24 to deploy the air bag 26.

At least one mass sensor 40 may be placed in, below, or proximate the seat 14 to determine the mass of the occupant 12. For example, it is known to use strain gages attached to seat components to determine the strain on the seat components caused by the occupant 12 sitting on the seat 14 and thereby determine the mass of the occupant 12. Preferably at least one load cell is placed in the seat 14 or below the seat to determine the mass of the seated occupant. The mass sensor is in electrical communication with the controller 35. One skilled in the art could devise alternative methods of determining the occupant's mass. Alternatively, several mass sensors 40 could be used together to provide more accurate measurements.

The tracking sensor or a tracking sensor unit 50 is placed in the interior 11 of the vehicle to determine the position and physical characteristics of the occupant 11 and to communicate that information to the controller 35. Preferably, one tracking sensor unit 50 is provided on or in the headliner 28 or the vehicle roof 13 approximately over the seated occupant 12. More preferably, the tracking sensor unit 50 will have one radar transmitter 50a and at least one radar receiver 50b. Although one radar receiver 50b will provide sufficient information, it is even more preferred for the tracking sensor unit 50 to have multiple radar receivers 50b. Multiple sensors and/or sensors 50 are preferable used to allow triangulation to accurately measure the reflected signal and provide a detailed three dimensional view of the occupant. Radars are the preferred sensors because the signals sent and received by the tracking sensor unit 50 can penetrate objects that may cover a portion of the occupant and cause false position signals such as a newspaper, map, hat, and briefcase. One skilled in the art could also place tracking sensors 50 in other locations, or use multiple locations, to obtain the position and physical characteristics of the occupant. Although radar transmitters and receivers are the preferred sensor type, the tracking sensors 50 may also be, for example, ultrasonic sensors, optical sensors, electric capacitance, passive infrared, or thermo viewing. The location of the tracking sensors 50 will vary for different passengers and different vehicles. However, one skilled in the art could devise alternative locations that will provide sufficient information.

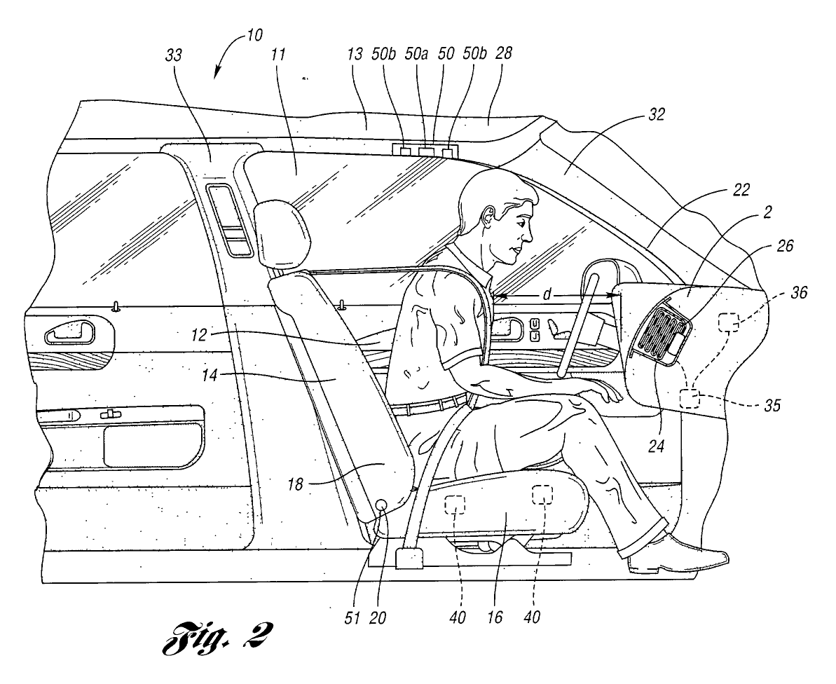

The tracking sensors 50 detect the presence and position of the occupant 12 and also determine key physical characteristics of the occupant. For example, the tracking sensors 50 may detect if the occupant 12 is seated properly, as shown in FIG. 1, or if the occupant is out of position or “in the red zone”, as shown in FIG. 2.

Out of position or “in the red zone” means that the occupant 12 is in a position where deployment of the air bag may cause more harm than good. For example, if the occupant is seated at the edge of the seat 14 and leaning forward, the occupant may be too close to the air bag 26. At this position, the deploying air bag may contact the occupant 12 with excessive force. Accordingly, the system is designed to either reduce the rate of inflation of the air bag 26 or to prevent the air bag from deploying. At a reduced rate of inflation, the air bag 26 will offer some protection to the occupant but minimize potential adverse affects.

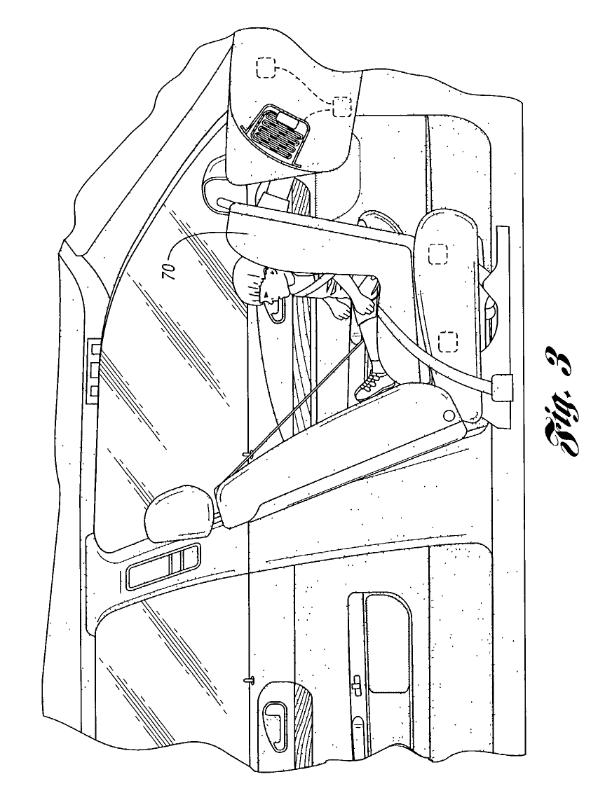

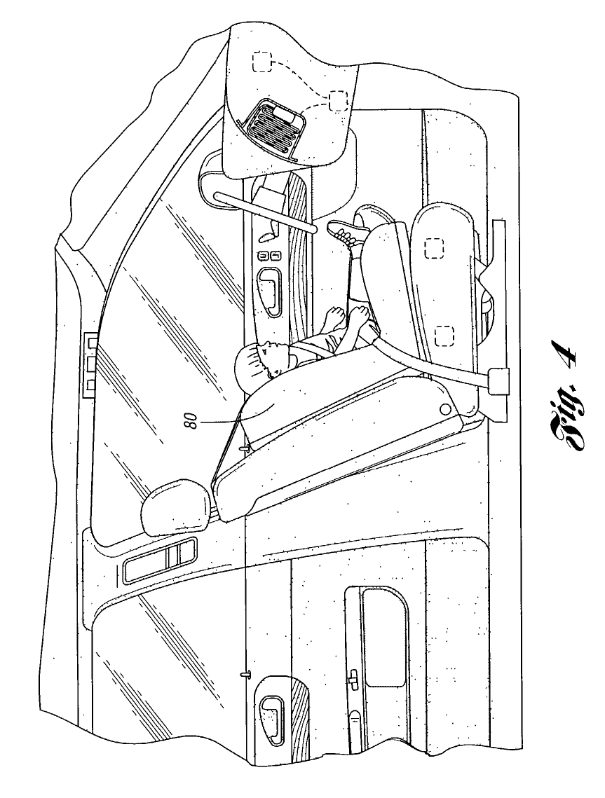

Similarly, the rate of inflation for the air bag 26 should be slowed down or the deployment of the air bag should be prevented if the occupant in the seat is an infant in a rear facing child seat 70, as shown in FIG. 3, or a small child in a forward facing child seat 80, as shown in FIG. 4. The triangulation method provides an accurate three dimensional representation of the area proximate the car seat and can determine if a car seat is present and which direction it faces.

There are other instances when the rate of inflation for the air bag 26 should be slowed down or the deployment of the air bag should be prevented such as when the occupant has their feet up on the dash board or has a large object on their lap. Additionally, the air bag 26 should not be deployed when there is no one in the front seat.

The tracking sensors 50 also measure key physical characteristics of the occupant 12 such as the distance hs from the head 12h to the shoulder 12s and the distance h from the seat 14 to the head 12h . As discussed above, the radar transmitters 50a and receivers 50b can penetrate obscuring objects like hats, papers, and clothes to find the real position of the occupant in three dimensions. Studies have shown that a very accurate method of classifying an occupant is determining either the distance hs from the occupant's head 12b to the occupant's shoulder 12s or the distance h from the seat 14 to the occupant's shoulder 12s. Alternatively, the occupant could be classified using both distances hs and h to provide a more accurate determination.

Further, a sensor 51 may be provided at the pivot point 20 to determine the inclination of the seat back 18. Other sensors (not shown) could be provided along the seat 14 or seat tracks (not shown) to determine the position of the seat. As with the other sensors, these sensors would also be electrically connected to the controller 35.

To provide broader protection, the controller 35 may be connected to other vehicle systems to determine, for example, the rate of speed of the vehicle, seat belt buckle status, seat position, or vehicle turn rate.

The controller 35 receives the information from the tracking sensors 50 and the mass sensor 40 and determines is there is a person sitting in the seat 14. If there is a person in the seat, the controller 35 determines a distance d that the occupant 12 is from the dash board 22. If the occupant is too close, the air bag module 24 either deploys the air bag 26 at a reduced speed or prevents the air bag from deploying. The controller also determines the size of the occupant by evaluating the mass of the occupant and at least one of the distances hs and h of the occupant. As previously discussed, other sensors may be provided to give additional information. An algorithm determines the rate of deployment of the air bag based on these specific characteristics and data table.

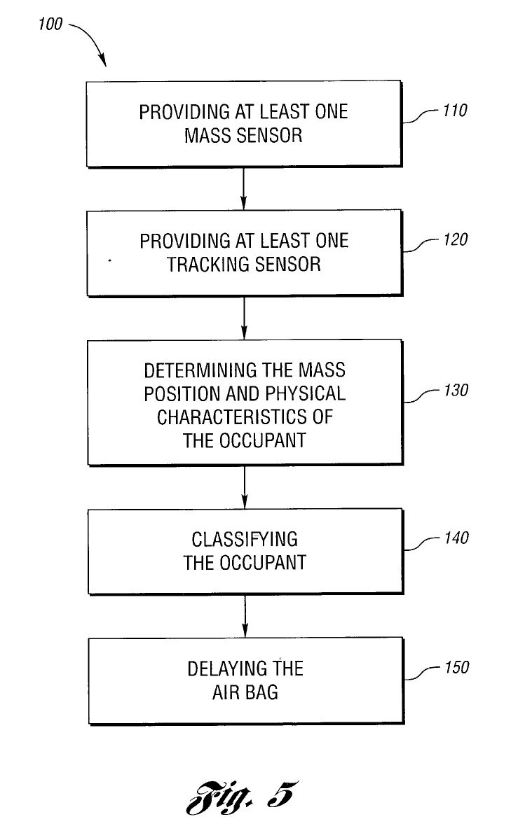

The present invention also provides a method of determining the rate of deployment for an air bag depicted generally as 100 and shown in FIG. 5. At block 110, at least one mass sensor to determine the mass of an occupant is provided. At least one tracking sensor to determine the position and physical characteristics of the occupant is provided at block 120. The method determines the position and physical characteristics of the occupant using the at least one mass sensor and the at least one tracking sensor as shown at block 130. The occupant is classified based a distance from the air bag to the occupant, a mass of the occupant, and at least one of a distance between the occupant's head and shoulders or a distance between the occupant's head and the seat bottom as shown at block 140. Lastly, the air bag is deployed at a predetermined rate dependent on the classification of the occupant as shown at block 150.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for determining the rate of deployment for an air bag in a vehicle, including a seat having a seat bottom, the method comprising:
providing at least one mass sensor to determine the mass of an occupant;
providing at least one tracking sensor to determine the position and physical characteristics of the occupant;
determining the mass, position, and physical characteristics of the occupant using the at least one mass sensor and the at least one tracking sensor;
classifying the occupant based a distance from the air bag to the occupant, a mass of the occupant, and at least one of a distance between the occupant's head and shoulders or a distance between the occupant's head and the seat bottom; and
deploying the air bag at a predetermined rate dependent on the classification of the occupant.

2. The method of claim 1 wherein the step of classifying the occupant is also based on the other of the distance between the occupant's head and shoulders and the distance between the occupant's head and the seat bottom.

3. The method of claim 1 wherein vehicle has an occupant seat, the step of providing at least one mass sensor comprises providing at least one mass sensor in the occupant seat.

4. The method of claim 1 wherein the vehicle has an interior, and wherein the step of providing at least one tracking sensor comprises placing the at least one tracking sensor in the interior of the vehicle over the occupant.

5. A system for determining the rate of deployment for an air bag in a vehicle to protect an occupant, the vehicle having an interior and a seat with a seat bottom, the system comprising;
an air bag module attached to the interior of the vehicle, the air bag module having an air bag;
at least one mass sensor in the interior of the vehicle to determine the mass of an occupant;
at least one tracking sensor in the interior of the vehicle to determine the position and physical characteristics of the occupant; and
a computing system electrically connected to the at least one mass sensor, the at least one tracking sensor, and the air bag module that
receives information about the position and physical characteristics of the occupant from the at least one sensor;
determines the classification of the occupant based on a distance from the air bag to the occupant, a mass of the occupant, and at least one of a distance between the occupant's head and shoulders or a distance between the occupant's head and the seat bottom; and
determines the rate of deployment of the air bag based on the classification of the occupant.

6. The system of claim 5 wherein the tracking sensors are radar sensors.

7. The system of claim 5 wherein the tracking sensors are selected from a group consisting of ultra sonic sensors, short pulse radar sensors, or optical beam sensors.

8. The system of claim 5 wherein the at least one tracking sensor has a radar transmitter and a plurality of radar receivers.

9. The system of claim 5 wherein the at least one mass sensor is at least one load cell located in the seat bottom.

10. The system of claim 5 further comprising a crash sensor attached to the vehicle and electrically connected to the controller.

11. The system of claim 5 wherein the computing system determines the classification of the occupant based also on the other of the distance between the occupant's head and shoulders and the distance between the occupant's head and the seat bottom.
